(19) United States
(12) Patent Application Publication
(10) Pub. No.: US 2025/0265028 A1
(43) Pub. Date: Aug. 21, 2025

(54) VEHICLE-MOUNTED DEVICE, IMAGE DISPLAY METHOD, AND STORAGE MEDIUM

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/036,559

(22) Filed: Jan. 24, 2025

(30) Foreign Application Priority Data
Feb. 15, 2024 (JP) 2024-021454

(51) Int. Cl. G06F 3/14; B60K 35/22; B60K 35/28

(52) U.S. Cl. CPC G06F 3/1423; B60K 35/22; B60K 35/28; B60K 2360/182; B60K 2360/188; B60K 2360/191

(57) ABSTRACT

A vehicle-mounted device includes: a detection unit that detects satisfaction of a pre-specified switching condition for switching a predetermined display among a plurality of display units, the plurality of display units being provided at the vehicle, and the predetermined display including a host vehicle image representing the vehicle; and a display processing unit that, in a case in which the detection unit detects that the switching condition is satisfied, performs processing to display the host vehicle image at the plurality of display units such that the host vehicle image migrates between the plurality of display units.

### CROSS-REFERENCE TO RELATED APPLICATION

This application is based on and claims priority under 35 USC 119 from Japanese Patent Application No. 2024-021454 filed on Feb. 15, 2024, the disclosure of which is incorporated by reference herein.

### BACKGROUND

### Technical Field

The present disclosure relates to a vehicle-mounted device, an image display method, a program product, and a non-transitory storage medium storing a program.

### Related Art

Japanese Patent No. 7,086,798 proposes a vehicle control device including: a display unit that displays an image; a recognition unit that recognizes objects including other vehicles present around the host vehicle; a driving control unit that generates a target trajectory of the host vehicle on the basis of a state of an object recognized by the recognition unit and controls one or both of speed and steering of the host vehicle on the basis of the generated target trajectory; and a display control unit that superimposes an image representing another vehicle recognized as the object by the recognition unit on an image representing a road on which the host vehicle is present and displays the superimposed image at the display unit. A first image representing a first vehicle, which is one of other vehicles recognized as objects and which affects actions of the host vehicle controlled by the driving control unit, and a second image representing a second vehicle, which is different from the first vehicle and influences the generation of the target trajectory, are highlighted by the display control unit relative to a third image representing a third vehicle, which is different from the first vehicle and the second vehicle.

When plural display units are provided in a vehicle, such as a combination instrument cluster and a multimedia display or the like, and a display is to be switched between these display units, images representing the host vehicle may be displayed on the respective display units, providing separate impressions and making for poor visual association between the display units.

### SUMMARY

The present disclosure is made in consideration of the circumstances described above and provides a vehicle-mounted device, an image display method, a program product, and a non-transitory storage medium storing a program that may improve association of a host vehicle image representing a host vehicle in the perception of a vehicle occupant (user) when a predetermined display is switched among plural display units.

A vehicle-mounted device according to a first aspect includes: a detection unit that detects satisfaction of a pre-specified switching condition for switching a predetermined display among a plurality of display units, the plurality of display units being provided at the vehicle, and the predetermined display including a host vehicle image representing the vehicle; and a display processing unit that, in a case in which the detection unit detects that the switching condition is satisfied, performs processing to display the host vehicle image at the plurality of display units such that the host vehicle image migrates between the plurality of display units.

According to the first aspect, the detection unit detects satisfaction of the pre-specified switching condition for the display to be switched among the plural display units provided at the vehicle.

In a case in which the detection unit detects that the switching condition is satisfied, the display processing unit carries out processing to display the host vehicle image representing the host vehicle at the plural display units such that the host vehicle image, which is the predetermined display, migrates between the plural display units. Therefore, when the display is switched between the plural display units, the host vehicle image migrates between the display units and association of the host vehicle image in the perception of a vehicle occupant may be improved.

In a vehicle-mounted device according to a second aspect, in the vehicle-mounted device according to the first aspect, the plural display units include: a first display unit that displays the host vehicle image together with results of detection of objects in a vicinity of the vehicle; and a second display unit that displays a captured image of the vicinity of the vehicle together with the host vehicle image.

According to the second aspect, association of the host vehicle image in the perception of a vehicle occupant between the two display units, the first display unit and the second display unit, may be improved.

In a vehicle-mounted device according to a third aspect, in the vehicle-mounted device according to the first aspect or the second aspect, the display processing unit controls at least one of coloring or transparency of the host vehicle image to be altered when controlling the host vehicle image to be displayed so as to migrate between the plurality of display units.

According to the third aspect, a vehicle occupant may be prevented from getting an illusion that the vehicle is moving due to a movement of the host vehicle image.

In a vehicle-mounted device according to a fourth aspect, in the vehicle-mounted device according to any one of the first to third aspects, in a case in which the detection unit detects that the switching condition is satisfied, the display processing unit controls the host vehicle image to migrate while an accelerator is released, and completes migration of the display between the plurality of display units in a case in which the accelerator is activated or a vehicle speed is at least a pre-specified vehicle speed.

According to the fourth aspect, when the vehicle starts running, which display unit attention should be paid to may be easily understood by a vehicle occupant.

In a vehicle-mounted device according to a fifth aspect, in the vehicle-mounted device according to any one of the first to fourth aspects, the display processing unit controls display of the host vehicle image so as to migrate along a progress direction of the vehicle.

According to the fifth aspect, an association between the display units may be expressed by the host vehicle image migrating in a direction matching a progress direction of the vehicle.

A sixth aspect is a non-transitory storage medium storing a program that causes a computer to execute image display processing, the image display processing including: detecting satisfaction of a pre-specified switching condition for switching a display among a plurality of display units, the plurality of display units being provided at a vehicle, and the predetermined display including a host vehicle image representing the vehicle; and, in a case in which it is detected that the switching condition is satisfied, controlling a host vehicle image to be displayed at the plurality of display units such that the host vehicle image migrates between the plurality of display units.

According to the sixth aspect, when the display is switched between plural display screens, association of the host vehicle image representing the host vehicle may be improved in the perception of a vehicle occupant.

A seventh aspect is a program product providing a program that causes a computer to execute image display processing, the image display processing including: detecting satisfaction of a pre-specified switching condition for switching a display among a plurality of display units, the plurality of display units being provided at a vehicle, and the predetermined display including a host vehicle image representing the vehicle; and, in a case in which it is detected that the switching condition is satisfied, controlling a host vehicle image to be displayed at the plurality of display units such that the host vehicle image migrates between the plurality of display units.

An eighth aspect is an image display method implemented by a computer, the image display method including: detecting satisfaction of a pre-specified switching condition for switching a display among a plurality of display units, the plurality of display units being provided at a vehicle, and the predetermined display including a host vehicle image representing the vehicle; and, in a case in which it is detected that the switching condition is satisfied, controlling a host vehicle image to be displayed at the plurality of display units such that the host vehicle image migrates between the plurality of display units.

According to the present disclosure as described above, a vehicle-mounted device, an image display method, a program product, and a non-transitory storage medium storing a program may be provided that may improve association of a host vehicle image representing a host vehicle in the perception of a vehicle occupant when a display is switched among plural display screens.

### BRIEF DESCRIPTION OF THE DRAWINGS

FIG. 1 is a schematic view of a cabin interior of a vehicle in which a vehicle-mounted device according to a present exemplary embodiment is mounted.

FIG. 2 is a block diagram illustrating structures of a control system of the vehicle-mounted device according to the present exemplary embodiment.

FIG. 3 is a block diagram illustrating principal structures of electronic systems of an instrument cluster ECU, a multimedia ECU, and an advanced driver assistance ECU of the vehicle-mounted device according to the present exemplary embodiment.

FIG. 4 is a view illustrating an example of an image displayed at a display screen.

FIG. 5 is a view illustrating an example of an image displayed at a multimedia display screen.

FIG. 6 is a view illustrating an example of display switching at the vehicle-mounted device according to the present exemplary embodiment in a case in which a display is switched from a state in which a captured image and an overhead image are displayed at a multimedia display screen to a state in which a vicinity monitoring image is displayed at a display screen, while the vehicle is stopped.

FIG. 7 is a view illustrating an example of display switching at the vehicle-mounted device according to the present exemplary embodiment in a case in which the vehicle stops in a state in which the vicinity monitoring image is displayed at the display screen, and then a display is switched to a state in which an image of autonomous parking, a parking assistance function or the like is displayed at the multimedia display screen.

FIG. 8 is a flowchart illustrating an example of a flow of processing carried out by the instrument cluster ECU and multimedia ECU of the vehicle-mounted device according to the present exemplary embodiment.

### DETAILED DESCRIPTION

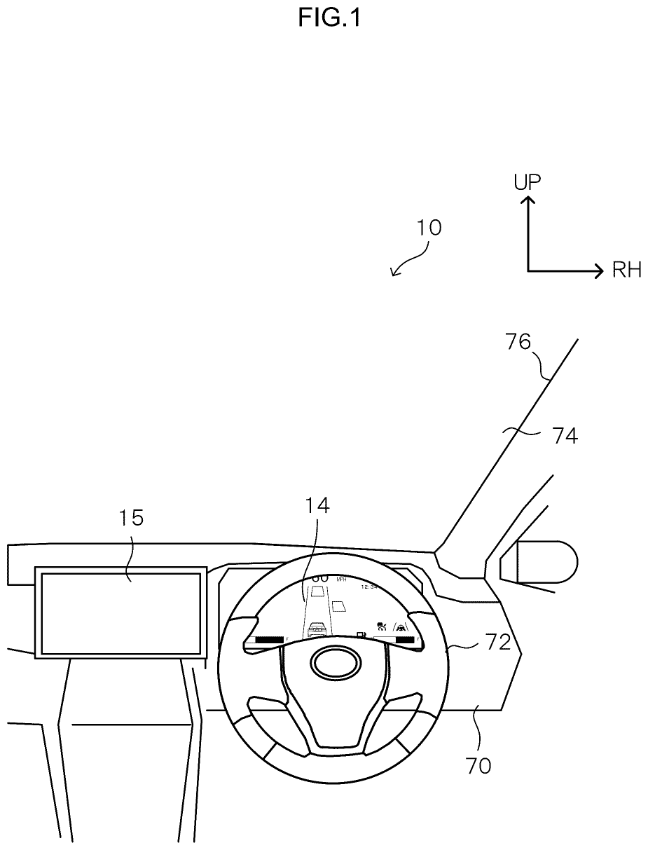

Below, an exemplary embodiment of the present disclosure is described in detail with reference to the attached drawings. FIG. 1 is a schematic view of a cabin interior of a vehicle in which a vehicle-mounted device according to a present exemplary embodiment is mounted. The arrow UP marked in FIG. 1 indicates the upper side in a vehicle vertical direction and the arrow RH indicates the right side in a vehicle width direction in view of a vehicle occupant seated in the vehicle. The vertical direction and left-and-right direction referred to in the descriptions below refer to, respectively, upper and lower in the vehicle vertical direction and left and right in the vehicle width direction as described above.

As illustrated in FIG. 1, an instrument panel 70 is provided at a front portion of a cabin interior of a vehicle 10. A windshield glass 74 is provided at a front end portion of the instrument panel 70. The windshield glass 74 extends in the vehicle vertical direction and the vehicle width direction, dividing the cabin interior from the cabin exterior.

A vehicle right side end portion of the windshield glass 74 is fixed to a vehicle right side front pillar 76. The front pillar 76 extends in the vehicle vertical direction, and the windshield glass 74 is fixed to a vehicle width direction inner side end portion of the front pillar 76. A vehicle left side end portion of the windshield glass 74 is fixed to a vehicle left side front pillar, which is not shown in the drawings.

The instrument panel 74 extends in the vehicle width direction, and a steering wheel 72 is provided at the vehicle right side of the instrument panel 70. That is, the present exemplary embodiment is an example of a right-hand drive car in which the steering wheel 72 is provided at the right side and a driver seat is set at the vehicle right side.

A display screen 14 that serves as an example of a first display unit is provided at a location corresponding to the front of the steering wheel 72 of the instrument panel 70, and a multimedia display screen 15 that serves as an example of a second display unit is provided at a central portion vicinity of the instrument panel 70. As examples, the display screen 14 and the multimedia display screen 15 are structured by touch panels containing liquid crystals, which display running (traveling) states of the vehicle, operation states of driver assistance equipment and the like, and detect touch operations.

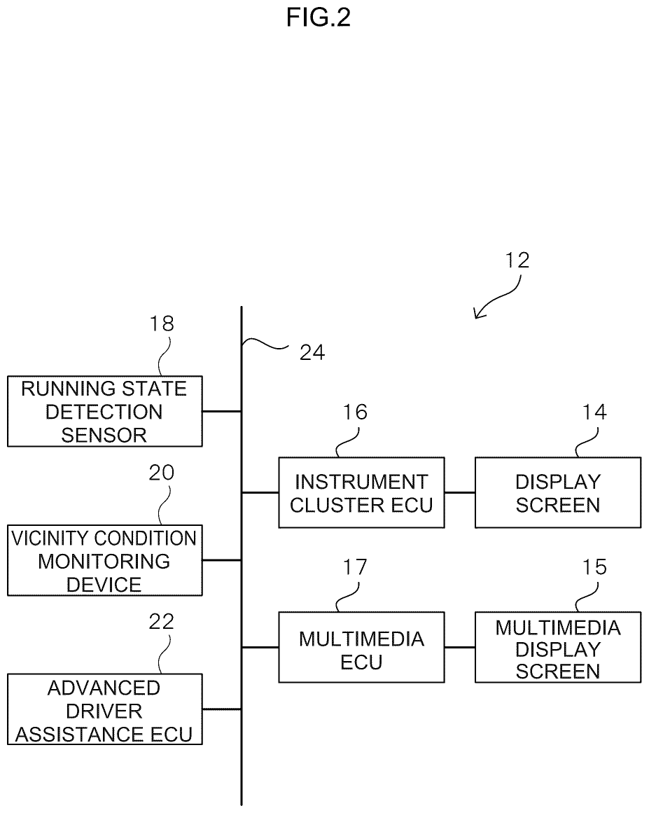

Now, structures of a control system of a vehicle-mounted device 12 according to the present exemplary embodiment is described. FIG. 2 is a block diagram illustrating the structures of the control system of the vehicle-mounted device 12 according to the present exemplary embodiment.

The vehicle-mounted device 12 according to the present exemplary embodiment includes an instrument cluster electronic control unit (ECU) 16, a multimedia ECU 17, running state detection sensors 18, a vicinity condition monitoring device 20, an advanced driver assistance ECU 22 and so forth, which are respectively connected to an in-vehicle network 24.

The instrument cluster ECU 16 and the multimedia ECU 17 respectively correspond to examples of a detection unit and an image processing unit.

The instrument cluster ECU 16 is connected to the display screen 14, controls the display screen 14, and performs processing to display results of the detection of objects in the vehicle's vicinity. The instrument cluster ECU 16 performs processing to display plural instruments, processing to display various kinds of information of the vehicle, and so forth. When an abnormality or the like occurs in the vehicle, the instrument cluster ECU 16 reports the occurrence of the abnormality to a vehicle occupant by a display at the display screen 14. Examples of the various kinds of information of the vehicle displayed at the display screen 14 include operation states of the driver assistance equipment and so forth. A display mode of the display screen 14 may be switched by a switch or the like, which is not shown in the drawings, and may be changed to a display mode according to a preference of a driver.

The multimedia ECU 17 is connected to the multimedia display screen 15, controls the multimedia display screen 15, and performs processing to display captured images imaging the vehicle vicinity. The multimedia ECU 17 also performs processing to display information such as map images, navigation images, vehicle vicinity monitoring results, settings screens for various functions of the vehicle, and so forth.

The running state detection sensors 18 detect running or traveling states of the vehicle 10. The running state detection sensors 18 include at least one of various sensors such as, for example, a vehicle speed sensor, an acceleration sensor, a gyro sensor, an accelerator position sensor, a brake sensor and the like.

The vicinity condition monitoring device 20 detects information representing conditions such as states of the environment in the vicinity of the vehicle. The vicinity condition monitoring device 20 includes at least one of various devices such as, for example, a global positioning system (GPS) device, on-board communication equipment, a navigation system, a radar device, an ultrasound sensor, a camera and the like.

The advanced driver assistance ECU 22 has functions of acquiring vicinity information detected by the vicinity condition monitoring device 20 monitoring the vicinity, providing the vicinity information to other ECUs, and controlling steering, brakes and the like when required. For example, in a case in which a release of the accelerator is detected by the running state detection sensors 18 and a vehicle in front, an intersection or the like is detected by the vicinity condition monitoring device 20, the advanced driver assistance ECU 22 carries out processing to control the brakes and assist with deceleration. More specifically, the advanced driver assistance ECU 22 implements control of various driver assistance functions such as: an adaptive cruise control function that controls acceleration and deceleration to run while tracking speed changes of a preceding vehicle; a lane-tracing assistance function that gives warnings of the possibility of deviating from a vehicle lane or road and assists in some steering operations in order to avoid deviating from the vehicle lane or road; a lane change assistance function that assists with some steering operations required for a lane change; or the like.

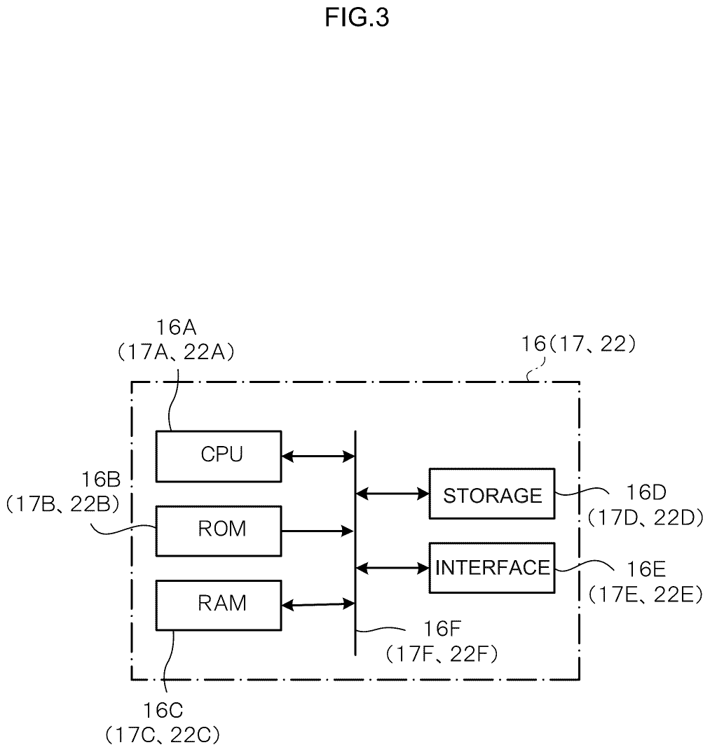

FIG. 3 is a block diagram illustrating principal structures of electronic systems of the instrument cluster ECU 16, the multimedia ECU 17 and the advanced driver assistance ECU 22 of the vehicle-mounted device 12 according to the present exemplary embodiment. The instrument cluster ECU 16, the multimedia ECU 17 and the advanced driver assistance ECU 22 may basically be configured as general-purpose computers. The instrument cluster ECU 16 is taken as being representative and described here; corresponding reference symbols for the other ECUs are shown in FIG. 3.

The instrument cluster ECU 16 is structured by a general-purpose computer including a central processing unit (CPU) 16A, read-only memory (ROM) 16B, random access memory (RAM) 16C, storage 16D, an interface (I/F) 16E, a bus 16F and such.

The CPU 16A is a central arithmetic processing unit that, by executing various programs, controls overall operations of the device. The ROM 16B stores, in advance, various control programs, such as a display program for the vehicle and the like, and various parameters and so forth. The RAM 16C is used as a work area during execution of the various programs by the CPU 16A. The storage 16D is structured by any of various memory units, such as a hard disk drive (HDD), solid state drive (SSD), flash memory or the like, and stores various kinds of data, application programs and the like. The interface 16E may be connected to the in-vehicle network 24, and transmits and receives various kinds of data to and from ECUs other than the instrument cluster ECU 16 and the like that are connected to the in-vehicle network 24. The various parts of the instrument cluster ECU 16 described above are electronically connected to one another by the bus 16F. In the present exemplary embodiment, the display program for the vehicle is described as being stored at the ROM 16B, but modes are possible in which the display program for the vehicle is stored at the storage 16D.

In response to the display program for the vehicle stored at the ROM 16B being executed by the CPU 16A, the instrument cluster ECU 16 functions as the detection unit and the display control unit. Similarly, in response to a display program for the vehicle stored at a ROM 17B being executed by a CPU 17A, the multimedia ECU 17 functions as the detection unit and the display control unit.

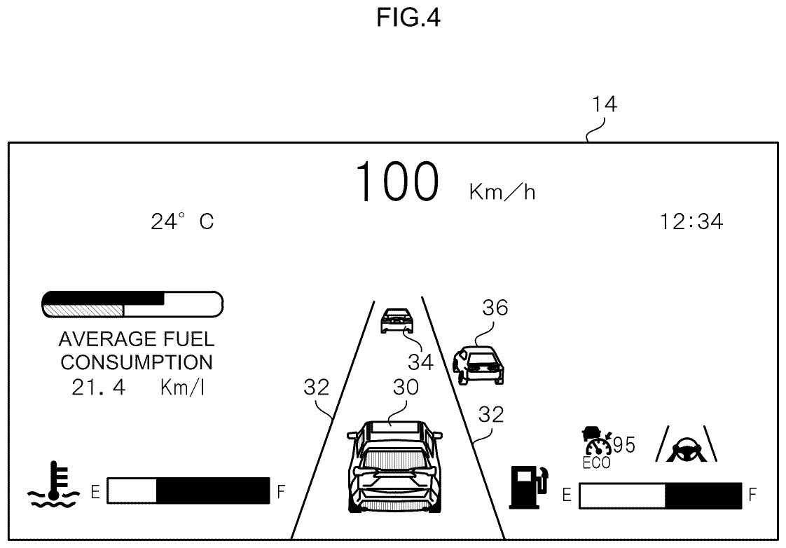

Now, examples of images displayed at the display screen 14 are described. FIG. 4 is a view illustrating an example of an image displayed at the display screen 14.

The display screen 14 is equipped to function as a combination instrument cluster and mainly displays various kinds of information during running. As examples of the various kinds of information displayed at the display screen 14, information relating to driver assistance functions, states during running of the vehicle and so forth are displayed.

For example, the display screen 14 may display a situation awareness (SA) view display (i.e., a vicinity monitoring display) that shows vehicle conditions in the vicinity of the vehicle. In the vicinity monitoring display, a host vehicle image 30 representing the vehicle 10 (i.e., the host vehicle) is displayed, and conditions in the vicinity of the host vehicle are reported to a vehicle occupant by displays of results of detection of objects in the vicinity of the vehicle 10. For example, object images representing objects (for example, vehicles such as a preceding vehicle and the like) located in the vicinity of the host vehicle that are detected by the running state detection sensors 18 and/or the vicinity condition monitoring device 20 are displayed around the host vehicle image 30.

More specifically, as illustrated in FIG. 4, The host vehicle image 30 and the vicinity monitoring image are displayed at the display screen 14. As the vicinity monitoring image, white lines 32 representing a traffic lane, a preceding vehicle image 34 representing a preceding vehicle and a vicinity vehicle image 36 representing a vicinity vehicle, which are examples of object images, are displayed. The preceding vehicle image 34 and vicinity vehicle image 36 are displayed on the basis of, for example, information from ultrasound sensors such as a clearance sonar or the like serving as the vicinity condition monitoring device 20.

Beside the vicinity monitoring image, the display screen 14 may also display icons representing various driver assistance functions and various kinds of vehicle information such as running speed, water temperature, remaining fuel, average fuel consumption, air temperature outside the vehicle, time and the like.

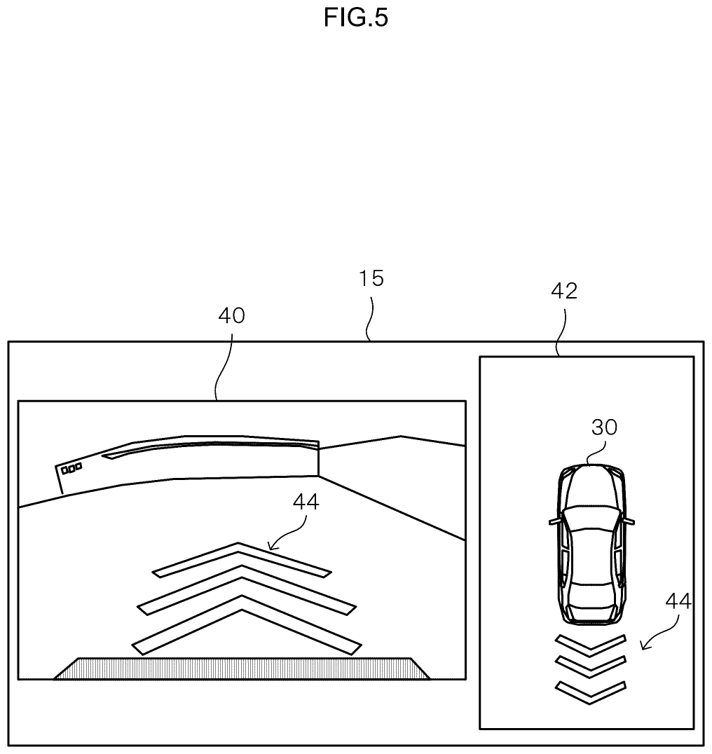

Now, examples of images displayed at the multimedia display screen 15 are described. FIG. 5 is a view illustrating an example of an image displayed at the multimedia display screen 15.

As an example of displayed content that is principally displayed at the multimedia display screen 15 during parking, a rear camera video image, an image relating to parking assistance, an image displayed during autonomous parking or the like is displayed.

For example, as illustrated in FIG. 5, a captured image 40 imaging the vicinity (for example, the rear) of the vehicle 10 is displayed at the multimedia display screen 15, and an overhead image 42 that assists parking is also displayed. The example in FIG. 5 illustrates an example in which arrow images 44 that assist parking are displayed in both the captured image 40 and the overhead image 42.

In the vehicle-mounted device 12 according to the present exemplary embodiment that is structured as described above, in a case in which a predetermined display transitions or is switched among plural display units, the host vehicle image 30 representing the host vehicle may be displayed at the respective displays, providing separate impressions and making for poor visual association between the display screens in the perception of the vehicle occupant.

Accordingly, the vehicle-mounted device 12 according to the present exemplary embodiment detects satisfaction of a pre-specified switching condition for a predetermined display to be switched among the plural display units provided at the vehicle. In a case in which the vehicle-mounted device 12 detects that the pre-specified switching condition is satisfied, the vehicle-mounted device 12 carries out display control to display the host vehicle image 30 at the plural display units such that the host vehicle image 30 migrates between the plural display units. This display control causes the host vehicle image 30 to migrate while the accelerator is released, and terminates the switching of the display between the plural display units if the accelerator is activated or a vehicle speed is at least a pre-specified speed. Therefore, a vehicle occupant may be prevented from getting an illusion that the vehicle is moving due to by the movement of the host vehicle image 30.

In the present exemplary embodiment, both of the instrument cluster ECU 16 and the multimedia ECU 17 detect the satisfaction of the switching condition and carry out the display control such that the host vehicle image 30 migrates between the display screens. Thus, movement of the host vehicle image 30 is expressed, separate impressions of the display screens are suppressed, and association between the display screens may be improved in the perception of the vehicle occupant.

Now, display examples of the display screen 14 and the multimedia display screen 15 when the instrument cluster ECU 16 and the multimedia ECU 17 respectively carry out the display control are described.

As an example, a situation is described in which, from a state in which the captured image 40 and overhead image 42 are displayed at the multimedia display screen 15 while the vehicle is stopped, and then running starts and the vicinity monitoring image is displayed at the display screen 14.

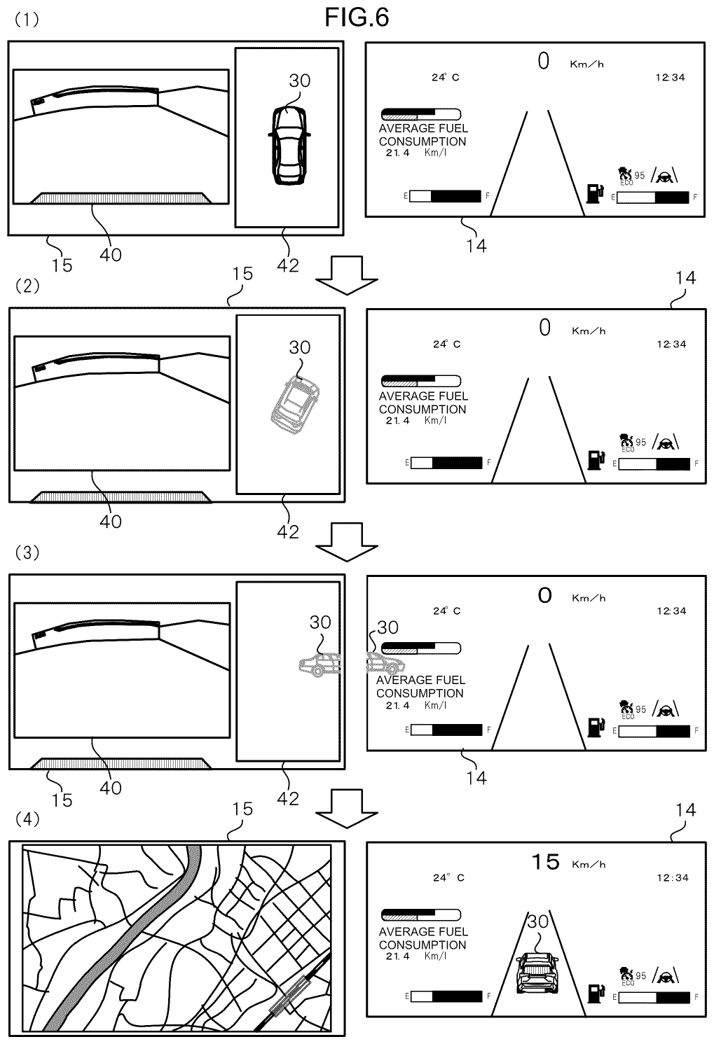

FIG. 6 is a view illustrating an example of display switching or transitioning at the vehicle-mounted device 12 according to the present exemplary embodiment in a case in which a display is switched from a state in which the captured image 40 and overhead image 42 are displayed at the multimedia display screen 15 while the vehicle is stopped to a state in which the vicinity monitoring image is displayed at the display screen 14.

For example, as illustrated in (1) of FIG. 6, the captured image 40 and overhead image 42 are displayed at the multimedia display screen 15. The host vehicle image 30 representing the host vehicle is displayed in the overhead image 42. The host vehicle image 30 displayed in the overhead image 42 shows the host vehicle as seen from above.

As is also illustrated in (1) of FIG. 6, icons representing various driver assistance functions and various kinds of vehicle information such as gear shift position, running speed, water temperature, remaining fuel, average fuel consumption, air temperature outside the vehicle, time and the like are displayed at the display screen 14.

Examples of satisfying the pre-specified switching condition for switching a display in this case include, a case in which a change in gear shift position from a parking position to a drive position or reverse position is detected, a case in which a display switch for the captured image, overhead image or the like (for example, a switch provided at the steering wheel or the like) is pressed, and the like. In response to a pre-specified switching condition for switching a display being satisfied, display of the host vehicle image 30 is controlled such that the host vehicle image 30 that has been displayed at the multimedia display screen 15 migrates to a pre-specified position of the display screen 14 (for example, a substantially central position of the display screen 14 or the like). At this time, by changing a virtual viewpoint, the host vehicle image 30 is displayed with the viewpoint being changed from the image showing the host vehicle image 30 from above to an image showing the host vehicle image 30 from the side (see (2) of FIG. 6), and the host vehicle image 30 migrates from the multimedia display screen 15 to the display screen 14 (see (3) of FIG. 6). Then, the host vehicle image 30 is displayed with the viewpoint being changed to an image showing the host vehicle image 30 from above and rearward of the vehicle (see (4) of FIG. 6).

After the migration of the host vehicle image 30 is complete, an activation of the accelerator is detected, or the vehicle speed reaches at least a pre-specified speed, the host vehicle image 30 is displayed at the pre-specified position of the display screen 14 (see (4) of FIG. 6) and the switching processing of the display to the display screen 14 is terminated.

Meanwhile, from the state in which the captured image 40 and the overhead image 42 are displayed, the multimedia display screen 15 switches display to another image, such as the map image illustrated in (4) of FIG. 6, a navigation image or the like.

Now, as an alternative example, a situation is described in which, in a state in which the vicinity monitoring image is displayed at the display screen 14, the vehicle stops and the display is switched to a state in which an image of autonomous parking, a parking assistance function or the like is displayed at the multimedia display screen 15.

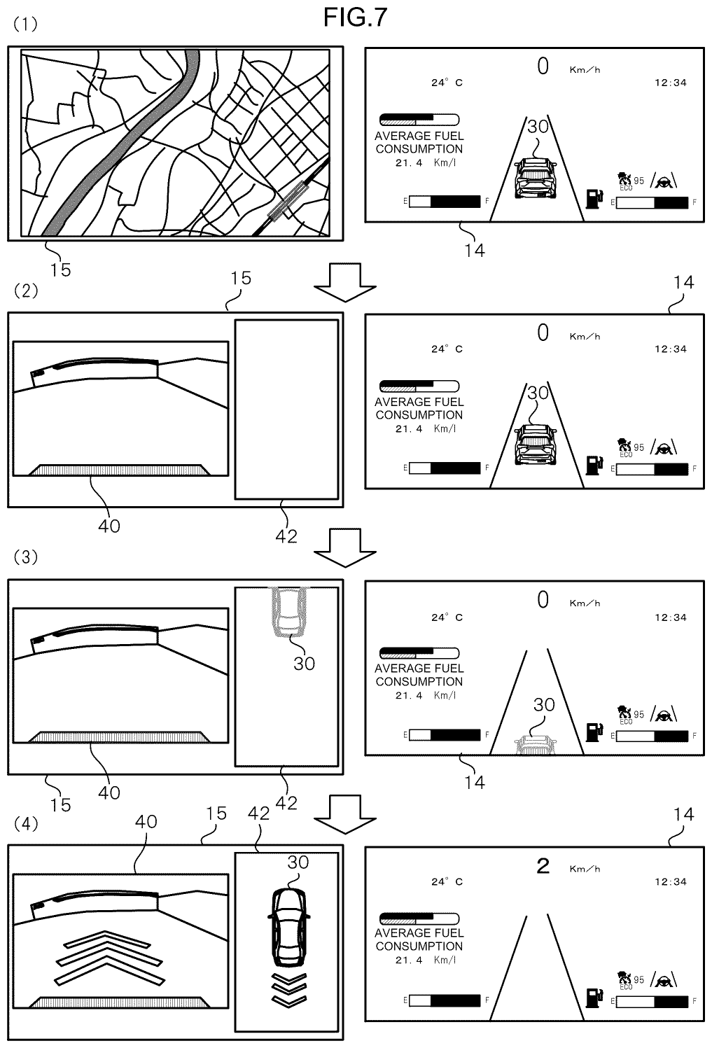

FIG. 7 is a view illustrating an example of display switching of the vehicle-mounted device 12 according to the present exemplary embodiment in which, in a state in which the vicinity monitoring image is displayed at the display screen 14, the vehicle stops and the display is switched to a state in which an image of autonomous parking, a parking assistance function or the like is displayed at the multimedia display screen 15.

As illustrated in (1) of FIG. 7, the host vehicle image 30 and the vicinity monitoring image (for example, the white lines 32 representing a traffic lane, the preceding vehicle image 34 when a preceding vehicle is present, the vicinity vehicle image 36 when a vicinity vehicle is present, and the like) are displayed on the display screen 14.

As also illustrated in (1) of FIG. 7, an image such as, for example, a map image, a navigation image or the like is displayed at the multimedia display screen 15.

Examples of satisfying the pre-specified switching condition for switching the display in this case include, a case in which the reverse gear shift position is detected, a case in which a display stop switch for the captured image, overhead image or the like is pressed (for example, the display is stopped by the aforementioned display switch for the captured image, overhead image or the like being operated plural times, for example, two or three times), a case in which a parking space is detected in the vicinity, a case in which it is determined from previous history that the vehicle is to be parked, or a case in which an autonomous parking function or parking assistance function is commanded. In response to a pre-specified switching condition for switching a display being satisfied, the display at the multimedia display screen 15 is switched from display of the map image, navigation image or the like to display of the captured image 40 and overhead image 42 (see (2) of FIG. 7). Display of the host vehicle image 30 is controlled such that the host vehicle image 30 that has been displayed in the display screen 14 retreats out of view along the progress direction of the vehicle 10 and, as the host vehicle image 30 disappears from the display screen 14, the host vehicle image 30 is displayed migrating into the display of the multimedia display screen 15. (See (3) of FIG. 7).

In a case in which the migration of the host vehicle image 30 is complete, an activation of the accelerator is detected, or the vehicle speed reaches at least a pre-specified speed, the host vehicle image 30 is displayed at a pre-specified position of the multimedia display screen 15 and the switching processing of the display to the multimedia display screen 15 is terminated (see (4) of FIG. 7).

When the host vehicle image 30 is migrating between the display screens, coloring of the host vehicle image 30 may be toned down as illustrated in FIG. 6 and FIG. 7, so as to prevent a vehicle occupant from getting an illusion that the vehicle is moving. Alternatively, the host vehicle image 30 may be made at least partially transparent. Further alternatively, a display mode of the host vehicle image 30 in which one or both of coloring and transparency is changed is possible.

When the host vehicle image 30 is migrating between the display screens, if various information of the vehicle is in the path of migration, the host vehicle image 30 may be displayed so as to move beneath the information of the vehicle, or the information of the vehicle may be displayed with priority. For example, the vehicle information may be displayed with priority by composing the displayed image of plural layers and displaying the host vehicle image 30 in a layer behind a layer in which the vehicle information is displayed.

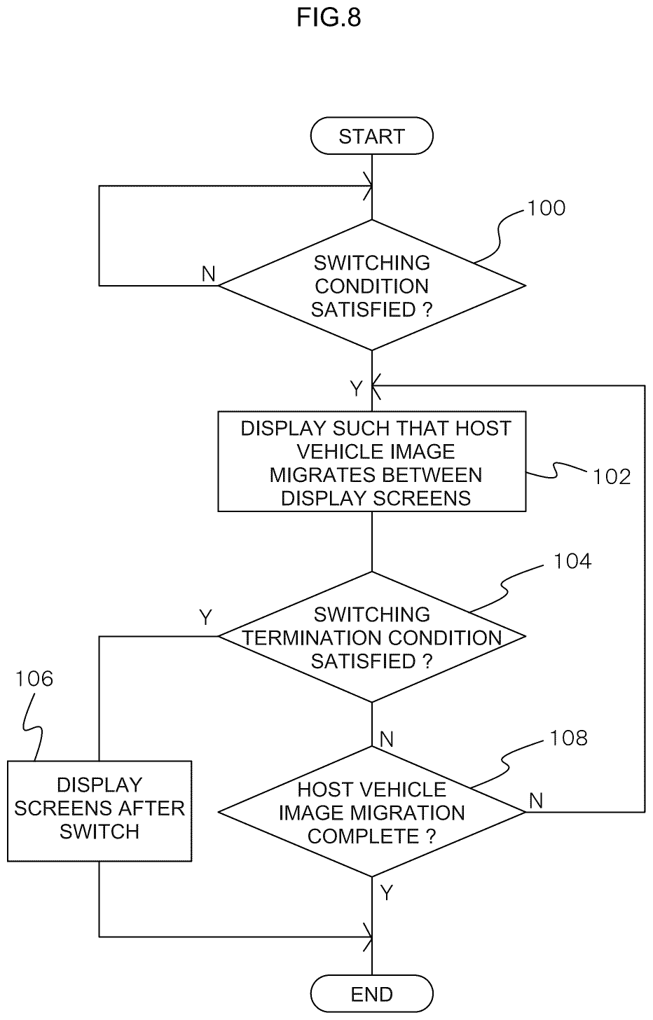

Now, processing that is carried out by the instrument cluster ECU 16 and multimedia ECU 17 of the vehicle-mounted device 12 according to the present exemplary embodiment structured as described above is described. FIG. 8 is a flowchart illustrating an example of a flow of the processing carried out by the instrument cluster ECU 16 and multimedia ECU 17 of the vehicle-mounted device 12 according to the present exemplary embodiment.

In step 100, the CPUs 16A and 17A make a determination as to whether a pre-specified switching condition for switching a display is satisfied. For example, in a case in which a display is switched from a state in which the vehicle is stopped and the captured image 40 and overhead image 42 are displayed at the multimedia display screen 15, to a state in which running of the vehicle starts and the vicinity monitoring image is displayed at the display screen 14, it is determined whether or not the gear shift position has changed from the parking position to a drive position or reverse position. In a case in which a display is switched from a state in which the vicinity monitoring image is displayed at the display screen 14, to a state in which the vehicle stops and an image of autonomous parking, a parking assistance function or the like is displayed at the multimedia display screen 15, it is determined whether or not the reverse shift position has been detected, whether or not a parking space has been detected in the vicinity, whether or not it is determined from previous history that the vehicle is to be parked, or whether or not an autonomous parking function or a parking assistance function is commanded. The CPUs 16A and 17A continues the determination until the result of the determination is affirmative and then proceed to step 102.

In step 102, the CPUs 16A and 17A controls display of the host vehicle image 30 such that the host vehicle image 30 migrates between the display screens, and proceed to step 104. That is, as illustrated in FIG. 6 and FIG. 7, display of the host vehicle image 30 at the respective display screens is controlled such that the host vehicle image 30 migrates from the display screen 14 to the multimedia display screen 15, or the host vehicle image 30 migrates from the multimedia display screen 15 to the display screen 14.

In step 104, the CPUs 16A and 17A make a determination as to whether a pre-specified switching termination condition is satisfied. This determination determines, for example, whether or not an activation of the accelerator has been detected or a vehicle speed at or above a pre-specified speed has been detected, before the migration of the host vehicle image 30 is complete. If the result of this determination is affirmative, the CPUs 16A and 17A proceed to step 106, and if the result is negative, the CPUs 16A and 17A proceed to step 108.

In step 106, the CPUs 16A and 17A display screens as a result of the switching and end this sequence of processing. That is, the respective images after the switching are displayed at the display screen 14 and the multimedia display screen 15, and the switching of the displays is terminated. Therefore, when running starts, the switching of the displays has been completed and a vehicle occupant may easily understood which display unit an attention should be paid to.

On the other hand, in step 108 the CPUs 16A and 17A make a determination as to whether the host vehicle image 30 has completed the migration. This determination is a determination as to whether the host vehicle image 30 has finished migrating to a pre-specified position. In a case in which the result of this determination is negative, the CPUs 16A and 17A return to step 102 and repeat the processing described above, and in a case in which the result is affirmative, the CPUs 16A and 17A end this sequence of processing.

As described above, as a result that the instrument cluster ECU 16 and the multimedia ECU 17 carry out these processing, displays are shown such that the host vehicle image 30 migrates between the display screens as illustrated in FIG. 6 and FIG. 7. Thus, association of the host vehicle image 30 displayed at the display screens may be improved in the perception of the vehicle occupant.

In the exemplary embodiment described above, as an example of plural display screens, a situation is described in which the two display screens that are the display screen 14 and multimedia display screen 15 are employed, but this is not limiting. For example, a display screen such as a head-up display (HUD) or the like may be employed instead of the multimedia display screen 15. Alternatively, these three display screens may be employed and displays may be controlled such that the host vehicle image 30 migrates between these display screens. Alternatively, displays may be controlled such that the host vehicle image 30 migrates between four or more display screens.

In the exemplary embodiment described above, the instrument cluster ECU 16 controls the display screen 14 and the multimedia ECU 17 controls the multimedia display screen 15, but this is not limiting. For example, a mode is possible in which a single ECU controls the display screen 14 and the multimedia display screen 15. Further, either one of the instrument cluster ECU 16 or the multimedia ECU 17 may perform control of switching of the host vehicle image 30.

The processing executed by the instrument cluster ECU 16 and multimedia ECU 17 according to the exemplary embodiment described above is described as software processing that is implemented by a program being executed, but this is not limiting. For example, the processing may be carried out by hardware such as a graphics processing unit (GPU), application-specific integrated circuit (ASIC), field-programmable gate array (FPGA) or the like. Alternatively, the processing may be implemented by combining both software and hardware. Further, if the processing is implemented in software, the program may be stored in any of various storage media and distributed.

The present disclosure is not limited by the above recitations. In addition to the above recitations, it will be clear that numerous modifications may be embodied within a technical scope not departing from the gist of the disclosure.

What is claimed is:

1. A vehicle-mounted device comprising:
a memory; and
a processor coupled to the memory, and that is configured to:
detect satisfaction of a pre-specified switching condition for switching a predetermined display among a plurality of display units is satisfied, the plurality of display units being provided at the vehicle, and the predetermined display including a host vehicle image representing the vehicle; and,
in a case in which the processor detects that the switching condition is satisfied, control the host vehicle image to be displayed at the plurality of display units such that the host vehicle image migrates between the plurality of display units.

2. The vehicle-mounted device according to claim 1, wherein the plurality of display units include:
a first display unit that displays the host vehicle image together with results of detection of objects in a vicinity of the vehicle; and
a second display unit that displays a captured image of the vicinity of the vehicle together with the host vehicle image.

3. The vehicle-mounted device according to claim 1, wherein the processor is further configured to control at least one of coloring or transparency of the host vehicle image to be altered when controlling the host vehicle image to be displayed so as to migrate between the plurality of display units.

4. The vehicle-mounted device according to claim 1, wherein the processor is further configured to, in a case in which it is detected that the switching condition is satisfied, control the host vehicle image to migrate while an accelerator is released, and complete migration of the display between the plurality of display units in a case in which the accelerator is activated or a vehicle speed is at least a pre-specified vehicle speed.

5. The vehicle-mounted device according to claim 1, wherein the processor is further configured to control display of the host vehicle image so as to migrate along a progress direction of the vehicle.

6. A non-transitory storage medium storing a program that causes a computer to execute image display processing, the image display processing comprising:
detecting satisfaction of a pre-specified switching condition for switching a display among a plurality of display units, the plurality of display units being provided at a vehicle, and the predetermined display including a host vehicle image representing the vehicle; and,
in a case in which it is detected that the switching condition is satisfied, controlling a host vehicle image to be displayed at the plurality of display units such that the host vehicle image migrates between the plurality of display units.

7. An image display method implemented by a computer, the image display method comprising:
detecting satisfaction of a pre-specified switching condition for switching a display among a plurality of display units, the plurality of display units being provided at a vehicle, and the predetermined display including a host vehicle image representing the vehicle; and,
in a case in which it is detected that the switching condition is satisfied, controlling a host vehicle image to be displayed at the plurality of display units such that the host vehicle image migrates between the plurality of display units.
